(19) United States
(12) Patent Application Publication
(10) Pub. No.: US 2009/0082040 A1
(43) Pub. Date: Mar. 26, 2009

(54) Method and Apparatus For Cellular Telephone Based Asset Tracking

(76) Inventor: Mark Kahn, Encino, CA (US)

Correspondence Address: PATENT VENTURE GROUP, 10788 CIVIC CENTER DRIVE, SUITE 215, RANCHO CUCAMONGA, CA, 91730, US

(21) Appl. No.: 11/861,086

(22) Filed: Sep. 25, 2007

(51) Int. Cl. H04Q 7/20

(52) U.S. Cl. 455/457

(57) ABSTRACT

An invention is provided for affording cellular telephone based asset tracking. Embodiments of the present invention establish a connection between a cellular telephone and an asset tracking device via a cellular telephone network. Positional data for the asset tracking device is provided to the cellular telephone via the asset telephone network, and positional data for the cellular telephone is determined. Once positional data for the asset tracking device and positional data for the cellular telephone are determined, asset indicia and cellular telephone indicia are displayed on a display of the cellular telephone. The asset indicia indicate a current position of the asset tracking device and the cellular telephone indicia indicate a current position of the cellular telephone.

### BACKGROUND OF THE INVENTION

1. Field of the Invention

This invention relates generally to asset tracking, and more particularly to methods and apparatuses for tracking assets utilizing cellular telephone networks.

2. Description of the Related Art

Today, situations often arise when mobile assets, such as automobiles, laptop computers, boats, and individuals need to be tracked. In response, prior art systems have been developed to allow assets to be tracked. These prior art systems generally utilize a stationary computer and global positioning system (GPS) coordinates to locate the assets. For example, trucking companies often utilize fleet management software to track the locations of their trucks in the field, as illustrated in FIG. 1.

FIG. 1 is a diagram showing a prior art fleet management system 100. The prior art fleet management system 100 utilizes GPS data received from GPS satellites 102 to determine the location of individual trucks 104 in the field. GPS is a satellite based navigation system that allows users to determine their position with respect to the Earth. In the prior art fleet management system 100, each truck 104 includes a GPS tracking system that receives GPS signals 108 from GPS satellites 102. The GPS tracking system detects and decodes the GPS signals 108 from the GPS satellites 102 orbiting the Earth, generally in geosynchronous orbits. The GPS signals 108 indicate the position of the satellite and the time at which the signals were sent.

To decode the satellite signals 108, each GPS tracking system first acquires the signals emitted from a minimum number of satellites 102. Once the receiver is locked on to the GPS signals 108, each truck's 104 current global position can be calculated. The calculated position data from each truck 104 then is transmitted, typically via radio frequency, to a central dispatch station 106. In this manner, a dispatch operator located at the central dispatch station 106 can view the location of each truck on a computer display. As can be appreciated the dispatch operator must remain at the stationary dispatch station 106 to locate the assets, in this example, the trucks 104.

However, assets often must be located when the user or owner is mobile and not located at a fixed location. For example, an owner of a laptop computer can lose the computer in a busy airport terminal. In this situation the computer may have been misplaced, or the computer may have been deliberately stolen. In either case, the owner of the computer generally needs to find the asset in a relatively short amount of time, since the owner may be ready to board a flight.

A more common example of such asset tracking is when an owner of an automobile parks their car in parking lot while attending an event or going shopping. When the owner later returns to the parking lot, the owner needs to locate the automobile. If the lot is crowded, such when attending a large concert or an amusement park, the task of finding the parked car can be quite difficult.

In such situations, the owner of the asset needs to be able to track the asset while being mobile. That is, the asset owner needs to be able to track the asset while they are moving and actively looking for the asset. For example, the owner of the lost laptop computer must be able to track the asset immediately in order to recover the computer. Similarly, the owner of the parked automobile must be able to track the automobile while walking in the parking lot.

In view of the foregoing, there is a need for methods and apparatuses for tracking assets in a mobile situation, where the tracker is not located in a stationary environment such as at a central dispatch station. The systems should be small and easily handled by the user. Moreover, the systems should not require undue burden on the operator to utilize.

### SUMMARY OF THE INVENTION

Broadly speaking, the present invention addresses these needs by providing cellular telephone based asset tracking. For example, in one embodiment a method for providing cellular telephone based asset tracking is disclosed. The method includes establishing a connection between a cellular telephone and an asset tracking device via a cellular telephone network. Positional data for the asset tracking device is provided to the cellular telephone via the cellular telephone network, and positional data for the cellular telephone also is determined. Once positional data for asset tracking device and positional data for the cellular telephone are determined, asset indicia and cellular telephone indicia are displayed on the display of the cellular telephone. The asset indicia indicates a current position of the asset tracking device and the cellular telephone indicia indicates a current position of the cellular telephone. In one embodiment, a map showing the current area surrounding the asset tracking device can be displayed. In this case, the asset indicia and cellular telephone indicia can be displayed on the map to assist the user in tracking an asset in proximity to the asset tracking device. To further assist the user in locating the asset, the displayed position of the cellular telephone indicia can be updated such that the displayed position of the cellular telephone indicia shows the new current position of the cellular telephone as the cellular telephone changes position. In addition, the displayed position of the asset indicia can be updated in a similar manner.

An additional method for providing cellular telephone based asset tracking is disclosed in an additional embodiment of the present invention. In this embodiment, as above, a connection is established between the cellular telephone and the asset tracking device via a cellular telephone network. Also as above, positional data for the asset tracking device is provided to the cellular telephone via the cellular telephone network, and positional data for the cellular telephone is determined. Once positional data for asset tracking device and positional data for the cellular telephone are determined, relative position indicia are displayed showing the relative position of the asset tracking device with respect to the cellular telephone. For example, in one embodiment, the relative position indicia can comprise a digital pointer that points in the direction of the asset tracking device relative to the cellular telephone. Similar to above, the digital pointer can be updated such that the displayed digital pointer points in a new direction of the asset tracking device relative to the cellular telephone as the cellular telephone changes position. Optionally, distance data can be displayed on the display of the cellular telephone. The distance data can indicate the distance between the cellular telephone and the asset tracking device. In this manner, the user can utilize the cellular telephone in a manner similar to a compass, wherein the pointer continually points in the direction of the asset.

In a further embodiment, an asset tracking device for providing cellular telephone based asset tracking is disclosed. The asset tracking device includes a cellular telephone receiver, a cellular telephone transmitter, and a modem in communication with the cellular telephone receiver and the cellular telephone transmitter. In addition, an identification data module is included that stores authorization data for an authorized cellular telephone. The asset tracking device also includes a microprocessor that is in communication with the modem and the identification data module. The microprocessor compares authorization data received from a cellular telephone with the stored authorization data to determine whether to allow positional data regarding the asset tracking device to be provided to the cellular telephone. In one embodiment, the asset tracking device includes global positioning system (GPS) circuitry capable of receiving GPS signal data for use in calculating the positional data for the asset tracking device. In this embodiment, the microprocessor can transmit the positional data to the cellular telephone upon determining the cellular telephone is authorized to receive the positional data. In a further embodiment, the positional data is determined by a cellular telephone network utilizing automatic location identification (ALI) technology. In this embodiment, the microprocessor transmits a signal to the cellular telephone network to provide the positional data to the cellular telephone upon determining the cellular telephone is authorized to receive the positional data.

Thus, embodiments of the present invention advantageously allow asset tracking in a mobile environment, where the user is not located at a stationary computer station. Moreover, embodiments of the present invention allow the user to track assets in a non-intrusive manner, utilizing a cellular telephone that is normally carried on the user. Hence, the user typically does not need to carry additional equipment other than their cellular telephone to track any number of asset tracking devices they are authorized to track. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a diagram showing a prior art fleet management system;

FIG. 2 is a diagram showing a cellular telephone based asset tracking system, in accordance with an embodiment of the present invention;

FIG. 3 is a block diagram showing an exemplary asset tracking device utilizing GPS signals to calculate current positional data, in accordance with an embodiment of the present invention;

FIG. 4 is a diagram showing a cellular telephone based asset tracking system, in accordance with an embodiment of the present invention;

FIG. 5 is a block diagram showing an exemplary asset tracking device utilizing ALI techniques to calculate current positional data, in accordance with an embodiment of the present invention;

FIG. 6 is a diagram showing an exemplary use of an asset tracking device to find a user's automobile, in accordance with an embodiment of the present invention;

FIG. 7 is a diagram showing an exemplary map based positional information display on a cellular telephone, in accordance with an embodiment of the present invention;

FIG. 8 is a diagram showing an exemplary relative positional information display on a cellular telephone, in accordance with an embodiment of the present invention; and

FIG. 9 is a flowchart showing a method for cellular telephone based asset tracking, in accordance with an embodiment of the present invention.

### DETAILED DESCRIPTION OF THE PREFERRED EMBODIMENTS

An invention is disclosed for providing cellular telephone based asset tracking. Broadly speaking, embodiments of the present invention utilize an asset tracking device to transmit positional data through a cellular telephone network to a cellular telephone for display to a user. In this manner, a user can employ their cellular telephone to track any asset in proximity to the asset tracking device. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

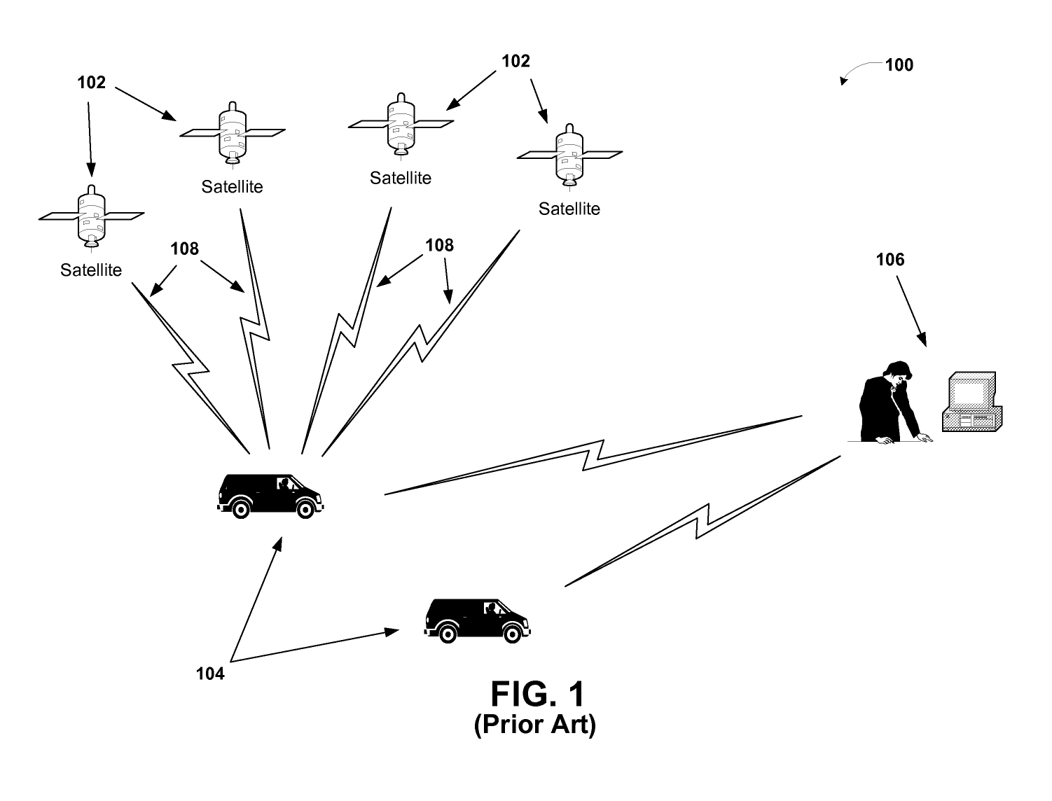

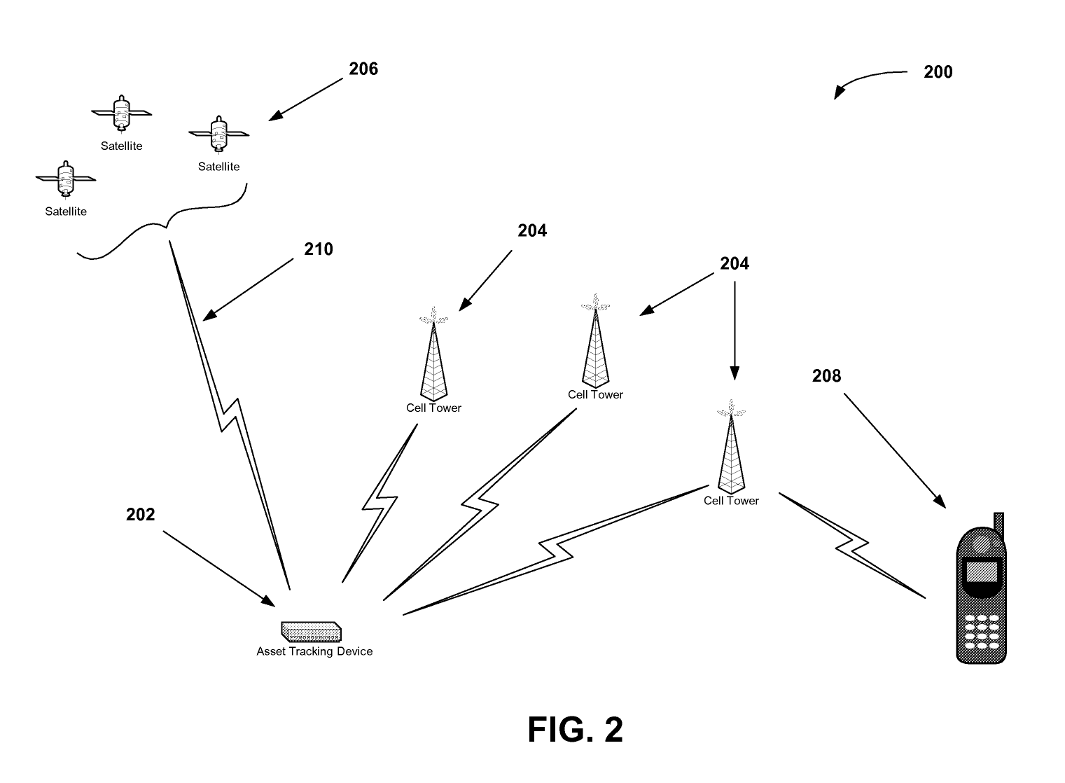

FIG. 1 was described in terms of the prior art. FIG. 2 is a diagram showing a cellular telephone based asset tracking system 200, in accordance with an embodiment of the present invention. The cellular telephone based asset tracking system 200 includes an asset tracking device 202, a plurality of cell towers 204, and a plurality of global positioning system (GPS) satellites 206. As mentioned above, embodiments of the present invention allow a user to employ a cellular telephone 208 to track assets in proximity to the asset tracking device 202.

In general, positional data is determined for the asset tracking device 202, for example via GPS, automatic location identification (ALI), Long Range Navigation (LORAN) system, Global Navigation Satellite System (GLONASS), or any other positional determination means, and transmitted to the cellular telephone 208. In the example of FIG. 2, the asset tracking device 202 utilizes GPS data received from the plurality of GPS satellites 206 to determine the position of the asset tracking device 202. As described previously, GPS is a satellite based navigation system that allows users to determine their position with respect to the Earth. A GPS device located within the asset tracking device 202 detects and decodes GPS signals 210 from the plurality of GPS satellites 206 orbiting the Earth, generally in geosynchronous orbits. The GPS signals 210 indicate the position of the satellites and the time at which the signals were sent.

To decode the satellite signals, GPS circuits within the asset tracking device 202 first acquire the signals emitted from a minimum number of satellites 206. Once the GPS circuits are locked on to the GPS signals 210, the current global position of the asset tracking device 202 can be calculated. The calculated positional data for the asset tracking device 202 then is transmitted to the cellular telephone 208 via the cell towers 204 of the cellular telephone network.

In addition to receiving positional data from the asset tracking device 202, embodiments of the present invention further calculate the current position of the receiving cellular telephone 208. Depending on availability and need, positional data for the cellular telephone 208 can be calculated based on GPS data, as described above, or ALI via the cellular telephone network. In either case, the current positional data for the cellular phone 208 is calculated for use in assisting the cellular telephone user in locating assets in proximity to the asset tracking device 202.

During operation, the calculated current positional data for the asset tracking device 202 is transmitted to the cellular telephone 208 for display to the user along with the calculated current positional data of the cellular telephone 208. In one embodiment, the tracking process is initiated when the cellular telephone 208 calls the asset tracking device 202. More specifically, the user of the cellular telephone 208 initiates contact with the asset tracking device 202, for example, by using a normal telephone call to the asset tracking device 202.

In one embodiment, the cellular telephone 208 can display a list of assets trackable via the cellular telephone 208. This list can include, for example, a list of a plurality of asset tracking devices 202, each designated with a unique identifier allowing the user to choose which asset to track. For example, a user may have a first asset tracking device 202 attached to their car and a second asset tracking device 202 attached to their laptop computer. When tracking an asset, the user can utilize the asset tracking menu to select a particular asset, for example the user can select car to track the user's car. In response, the cellular telephone 208 initiates contact with the selected asset tracking device 202, for example by calling the associated telephone number of the asset tracking device.

Once the cellular telephone 208 establishes contact with the asset tracking device 202, the asset tracking device 202 transmits its positional data to the cellular telephone 208. Because normal cellular telephone contact is established between the cellular telephone 208 and the asset tracking device 202, the positional data for the asset tracking device 202 can be transmitted to the cellular telephone 208 via the cell towers 204 of the cellular telephone network. Upon receiving the positional information from the asset tracking device 202, the cellular telephone 208 displays indicia indicating the position of the asset tracking device 202. As can be appreciated, the asset tracking device 202 generally is positioned within close proximity to a particular asset, for example within a car. Thus, the displayed position of the asset tracking device 202 generally coincides with the position of the associated asset.

In addition to displaying indicia indicating the position of the asset tracking device 202, one embodiment of the present invention displays indicia indicating the position of the cellular telephone 208 relative to the asset tracking device 202. As will be described in greater detail below, one embodiment of the present invention displays a map of the current surroundings of the cellular telephone 208 with indicia indicating the position of the asset tracking device 202 and the position of the cellular telephone 208. Generally, as the user moves while holding the cellular telephone 208, the displayed indicia are updated with new positions of each object.

In a further embodiment, as will be described in greater detail below, the cellular telephone 208 displays indicia indicating the relative position of the cellular telephone 208 to the asset tracking device 202. For example, the indicia can be a pointer pointing in the current direction of the asset tracking device 202 relative to the cellular telephone 208. As the user moves while holding the cellular telephone 208, the cellular telephone 208 updates the displayed indicia with new relative position of the cellular telephone 208 to the asset tracking device 202. In this manner, the cellular telephone 208 can be utilized in a manner similar to a compass, with the indicia indicating the direction to the desired asset.

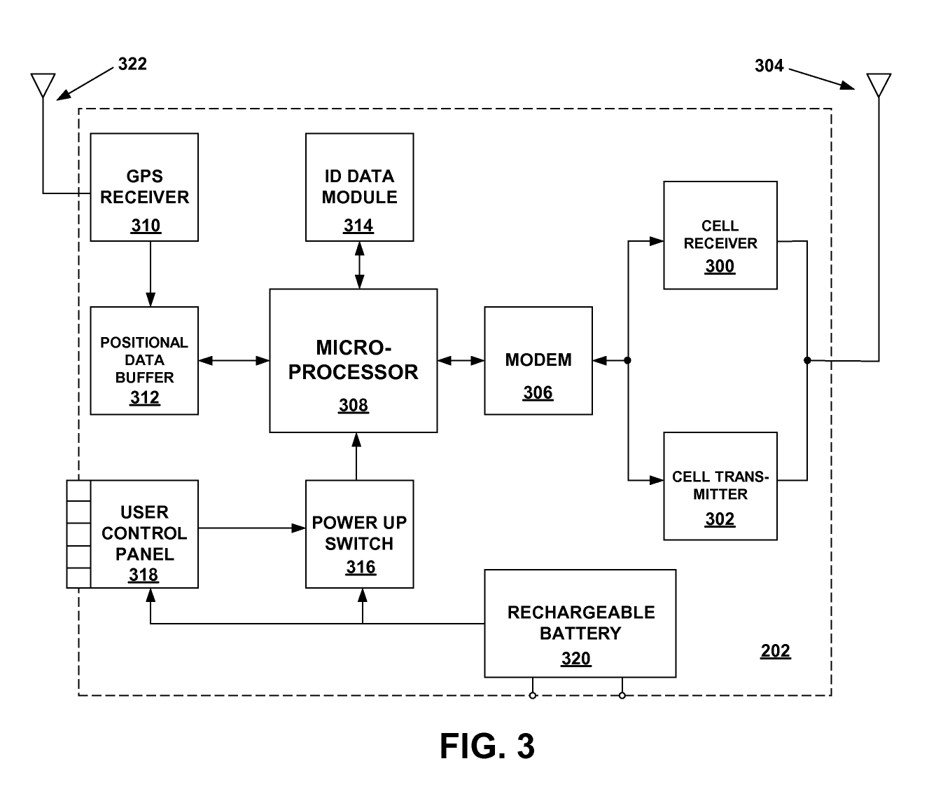

FIG. 3 is a block diagram showing an exemplary asset tracking device 202 utilizing GPS signals to calculate current positional data, in accordance with an embodiment of the present invention. The asset tracking device 202 includes a cellular receiver 300 and a cellular transmitter 302, both of which being coupled to a cellular antenna 304. The cellular receiver 300 and a cellular transmitter 302 are further coupled to a modem 306, which is coupled to a microprocessor 308. The asset tracking device 202 further includes a GPS antenna 322 coupled to a GPS receiver 310, which in turn is coupled to a positional data buffer 312 that provides positional data to the microprocessor 308. Also in communication with the microprocessor 308, is an identification data module 314 and a power up switch 316 that is coupled to a user control panel 318. A rechargeable battery 320 also is included to provide power to the components of the asset tracking device 202.

It should be noted that the asset tracking device 202 does not need to be capable of operating like a cellular telephone. That is, the asset tracking device 202 does not require, for example, a microphone to pickup voice data, or a speaker to produce sound waves, as is required by cellular telephone devices. Moreover, the asset tracking device 202 of the embodiments of the present invention does not require a screen, as is required in conventional cellular telephones. As is well known, conventional cellular telephones require a screen of some sort to produce feedback to the user, such as, dialed phone numbers, caller ID, address books, etc.

For example, in one embodiment, as illustrated in FIG. 3, the asset tracking device 202 does not include a microphone, speakers, or screen. As a result, the size of the asset tracking device 202 can be substantially smaller than the size required for conventional cellular telephones. In addition, because speakers, microphones, and screens are not required, the cost of manufacturing the asset tracking device 202 is substantially less than the cost to manufacture conventional cellular telephones.

In one embodiment, the asset tracking device 202 is setup by the user to provide extra security during operation. In this embodiment, the user enters a security code using the user control panel 318 to gain programming access to the asset tracking device 202. Once programming access is gained, the user can set the asset tracking device 202 to respond only to a particular authorized cellular telephone, or a set of authorized cellular telephones. In this case, the identifications of the authorized cellular telephones are stored in the identification data module 314. In addition, at some point prior to usage the cellular receiver 300 is assigned a cellular telephone number. This can occur at the manufacturer, at the point of purchase, as part of a cellular telephone network subscription process, or any other time as will be apparent to those skilled in the art after a careful reading of the present disclosure.

In one embodiment, after setup and each time the unit is powered on, the asset tracking device 202 is placed in a low power stand-by mode to conserve battery power. In stand-by mode power is provided to the cellular receiver 300, modem 306, and microprocessor 308. Generally, the remainder of the circuits remain off until powered on via the power up switch 316.

To begin tracking, the user selects the asset tracking device 202 from among selectable asset tracking devices utilizing a cellular telephone, as previously discussed. Once selected, the cellular telephone dials the pre-assigned telephone number corresponding to the cellular receiver 300 of the selected asset tracking device 202 and transmits cellular digital packet data (CDPD) via the cellular telephone system to the asset tracking device 202. Upon receiving the CDPD transmission, the cellular receiver 300 sends the received data through the modem 306 to the microprocessor 308. In response to receiving the data from the modem 306, the microprocessor 308 turns on the remainder of the circuits within the asset tracking device 202 utilizing the power up switch 316. Specifically, the microprocessor 308 powers on the cellular transmitter 302, identification data module 314, GPS receiver 310, and positional data buffer 312 utilizing the power up switch 316 upon receiving the data from the modem 306.

At this point, the GPS receiver 310 begins the process of receiving GPS positional data from the GPS satellites and storing the received positional data in the positional data buffer 312. The microprocessor 308 then utilizes the GPS receiver 310 and positional data buffer 312 to acquire the signals emitted from GPS satellites 206 and calculate the positional data for the asset tracking device 202. In addition, the microprocessor 308 utilizes the identification data module 314 to verify the received CDPD transmission has been received from an authorization cellular telephone. If verification fails, the microprocessor 308 terminates contact with the calling cellular telephone. Otherwise, the microprocessor 308 begins the process of transmitting the calculated positional data of the asset tracking device 202 through the cellular telephone network to the requesting cellular telephone using the cellular transmitter 302. In this manner, positional data is provided to the user via the cellular telephone connection for display on the cellular telephone as described above.

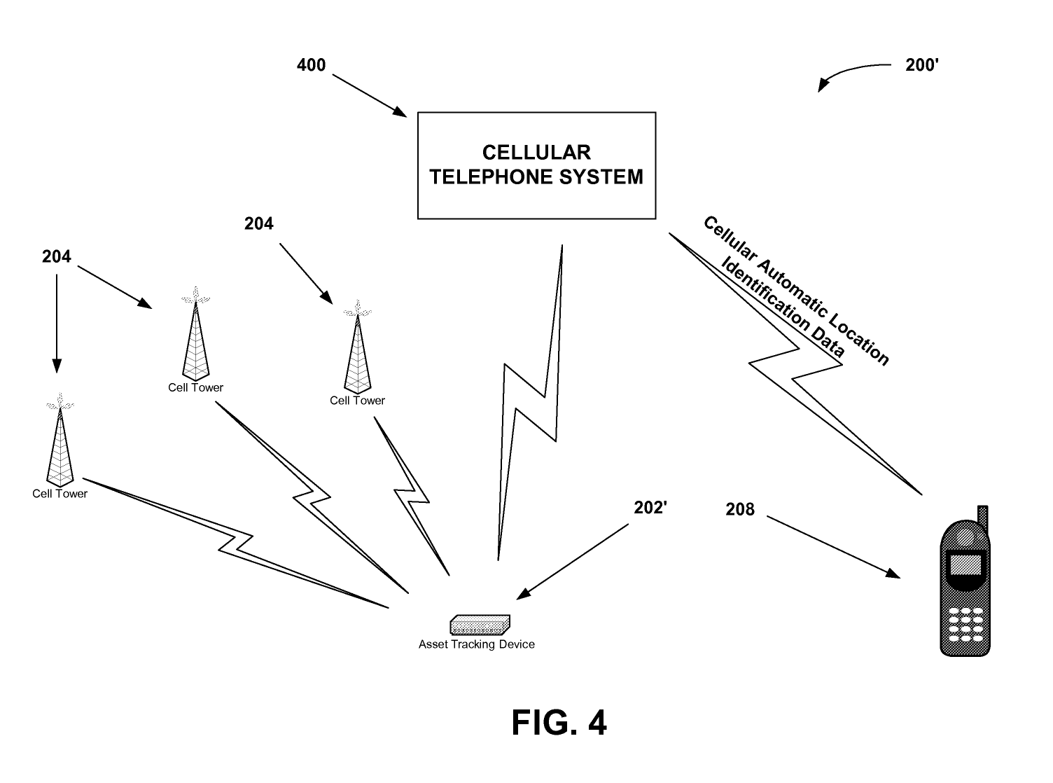

In addition to using GPS technology for determining positional data, the asset tracking device 202 can utilize automatic location identification (ALI) technology. FIG. 4 is a diagram showing a cellular telephone based asset tracking system 200′, in accordance with an embodiment of the present invention. The cellular telephone based asset tracking system 200′ includes an asset tracking device 202′, a plurality of cell towers 204, and a cellular telephone system 400.

In the example of FIG. 4, automatic location identification (ALI) data received from the cellular telephone system 400 is used to determine the position of the asset tracking device 202′. For example, the CDPD transmissions of the asset tracking device 202′ are measured to determine the angle of arrival (AOA) and time of arrival (TOA) at multiple fixed cell towers 204. The AOA and TOA are then utilized to calculate the positional data for the asset tracking device 202′. The calculated positional data for the asset tracking device 202′ then is transmitted to the cellular telephone 208 via the cellular telephone network 400.

As above, the tracking process can be initiated when the cellular telephone 208 calls the asset tracking device 202′. Once the cellular telephone 208 establishes contact with the asset tracking device 202′, positional data for the asset tracking device 202′ is calculated by the cellular telephone system 400 and transmitted to the cellular telephone 208. Because normal cellular telephone contact is established between the cellular telephone 208 and the asset tracking device 202, the positional data for the asset tracking device 202 can be calculated using known ALI techniques. Upon receiving the positional information from the asset tracking device 202′, the cellular telephone 208 displays indicia indicating the position of the asset tracking device 202′. As can be appreciated, the asset tracking device 202′ generally is positioned within close proximity to a particular asset, for example within a car. Thus, the displayed position of the asset tracking device 202′ generally coincides with the position of the associated asset.

As above, indicia indicating the position of the cellular telephone 208 relative to the asset tracking device 202′ can be displayed on the cellular telephone 202 in addition to displaying indicia indicating the position of the asset tracking device 202′. As will be described in greater detail below, indicia indicating the position of the asset tracking device 202′ and the position of the cellular telephone 208 can be displayed on a map of the current surroundings of the cellular telephone 208 and/or asset tracking device 202. In a further embodiment, as mentioned previously, the cellular telephone 208 can display indicia indicating the relative position of the cellular telephone 208 to the asset tracking device 202′, for example using a pointer pointing in the direction of the asset tracking device 202′.

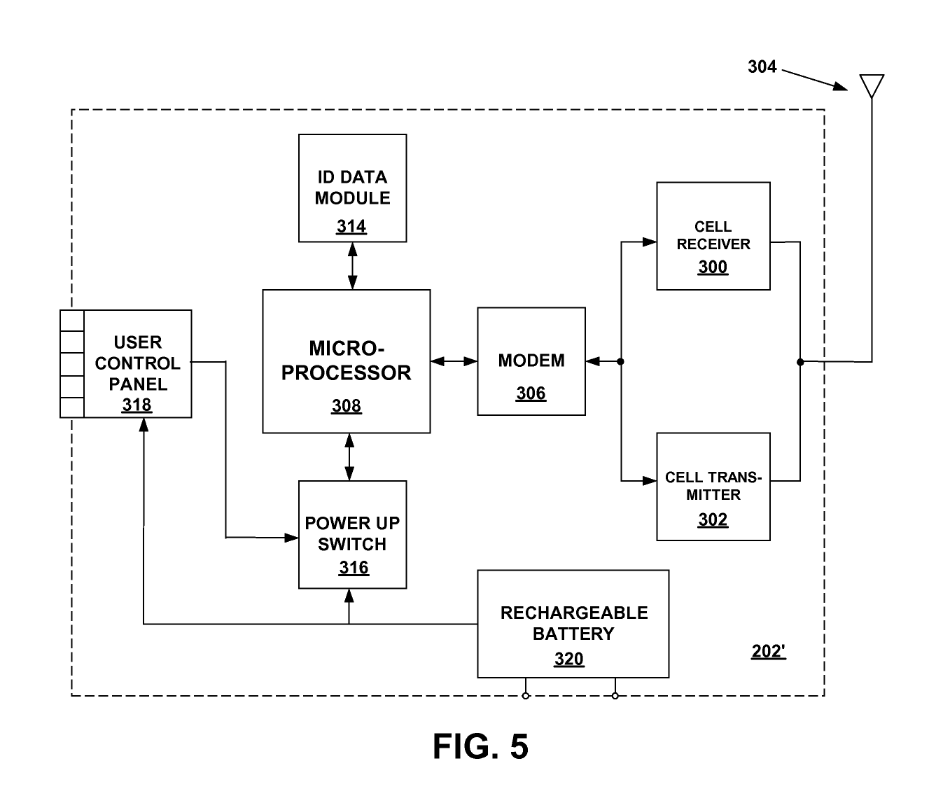

FIG. 5 is a block diagram showing an exemplary asset tracking device 202′ utilizing ALI techniques to calculate current positional data, in accordance with an embodiment of the present invention. The asset tracking device 202′ includes a cellular receiver 300 and a cellular transmitter 302, both of which being coupled to a cellular antenna 304. The cellular receiver 300 and a cellular transmitter 302 are further coupled to a modem 306, which is coupled a microprocessor 308. Also in communication with the microprocessor 308, is an identification data module 314 and a power up switch 316 that is coupled to a user control panel 318. A rechargeable battery 320 also is included to provide power to the components of the asset tracking device 202′.

Similar to above, in one embodiment the asset tracking device 202′ is setup by the user to provide extra security during operation. In this embodiment, the user enters a security code using the user control panel 318 to gain programming access to the asset tracking device 202. Once programming access is gained, the user can set the asset tracking device 202 to respond only to a particular authorized cellular telephone, or a set of authorized cellular telephones. In this case, the identifications of the authorized cellular telephones are stored in the identification data module 314. In addition, at some point prior to usage the cellular receiver 300 is assigned a cellular telephone number.

In one embodiment, after setup and each time the unit is powered on, the asset tracking device 202′ is placed in a low power stand-by mode to conserve battery power. In stand-by mode power is provided to the cellular receiver 300, modem 306, and microprocessor 308. Generally, the remainder of the circuits remain off until powered on via the power up switch 316.

To begin tracking using the ALI based asset tracking device 202′, the user selects the asset tracking device 202′ from among selectable asset tracking devices utilizing a cellular telephone, as discussed above. Once selected, the cellular telephone dials a pre-assigned telephone number corresponding to the cellular receiver 300 of the selected asset tracking device 202′ and transmits cellular digital packet data (CDPD) to the asset tracking device 202′ via the cellular the cellular telephone system. Upon receiving the CDPD transmission, the cellular receiver 300 sends the received data through the modem 306 to the microprocessor 308. In response to receiving the data from the modem 306, the microprocessor 308 turns on the remainder of the circuits within the asset tracking device 202′ utilizing the power up switch 316. Specifically, the microprocessor 308 powers on the cellular transmitter 302 and identification data module 314 utilizing the power up switch 316 upon receiving the data from the modem 306.

At this point, the microprocessor 308 utilizes the identification data module 314 to verify the received CDPD transmission has been received from an authorization cellular telephone. If verification fails, the microprocessor 308 terminates contact with the calling cellular telephone. Otherwise, the microprocessor 308 signals the cellular telephone system to provide positional data to the requesting cellular telephone.

The cellular telephone system calculates positional data for the asset tracking device 202′ using ALI techniques. In one embodiment, the cellular telephone system measures the CDPD transmissions of the asset tracking device 202′ to determine the AOA and TOA at multiple fixed cell towers. The AOA and TOA are then utilized to calculate the positional data for the asset tracking device 202′. The calculated positional data for the asset tracking device 202′ then is transmitted to the cellular telephone 208 via the cellular telephone network 400. In this manner, positional data is provided to the user via the cellular telephone connection for display on the cellular telephone as described above.

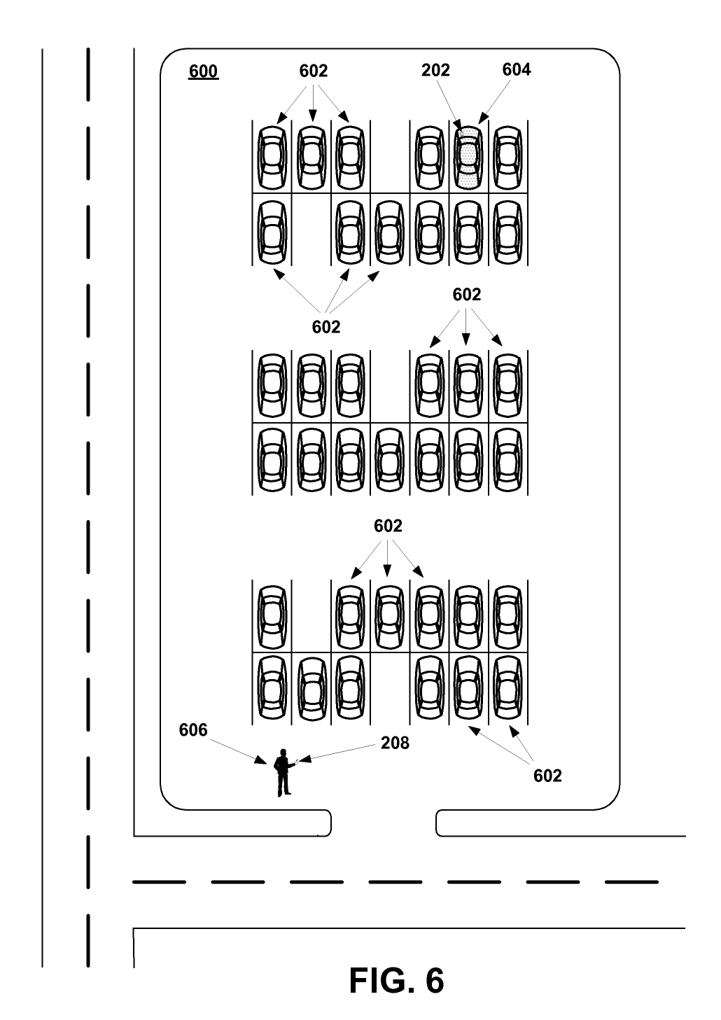

FIG. 6 is a diagram showing an exemplary use of an asset tracking device to find a user's automobile, in accordance with an embodiment of the present invention. In particular, FIG. 6 shows an exemplary parking lot 600 providing parking for a plurality of automobiles 602. Among the plurality of automobiles is the user's automobile 604. An asset tracking device 202 is located in proximity to the user's automobile 604. For example, the asset tracking device 202 can be located within the user's automobile 604, such as in the trunk, glove compartment, attached to a rechargeable battery charger, or in any other manner as will be appreciated by those skilled in the art after a careful reading of the present disclosure. In addition, at some prior time, a user 606 can program the asset tracking device 202 to authorize the user's cellular telephone 208 for tracking purposes. The user 606 also can program their cellular telephone 208 with contact information for the asset tracking device 202, such as the pre-assigned telephone number of the asset tracking device 202.

As can be appreciated, when the user 606 enters the parking lot 600, the user 606 can experience great difficulty in locating the user's automobile 604 among the plurality of other automobiles 602. To locate the user's automobile 604, the user 606 uses the cellular telephone 208 to display a list of assets trackable via the cellular telephone 208. This list can include, for example, a list of a plurality of asset tracking devices 202, each designated with a unique identifier allowing the user to choose which asset to track. For example, a user may have a first asset tracking device 202 attached to the user's automobile 604 and a second asset tracking device 202 attached to the user's laptop computer. The user can utilize the asset tracking menu to select a particular asset, for example in FIG. 6 the user can select automobile to track the user's automobile 604. In response, the cellular telephone 208 initiates contact with the selected asset tracking device 202 by calling the associated telephone number of the asset tracking device 202.

Once the cellular telephone 208 establishes contact with the asset tracking device 202, the asset tracking device 202 transmits its positional data to the cellular telephone 208. Upon receiving the positional data from the asset tracking device 202, the cellular telephone 208 displays indicia indicating the position of the asset tracking device 202. Because the asset tracking device 202 is positioned within close proximity to the user's automobile 604, the displayed position of the asset tracking device 202 generally coincides with the position of the user's automobile 604.

In addition to displaying indicia indicating the position of the asset tracking device 202, the cellular telephone 208 displays indicia indicating the position of the cellular telephone 208 relative to the asset tracking device 202. As will be described in greater detail below, one embodiment of the present invention displays a map of the current surroundings of the cellular telephone 208 with indicia indicating the position of the asset tracking device 202 and the position of the cellular telephone 208. In this manner, as the user moves while holding the cellular telephone 208, the displayed indicia are updated with new positions of each object.

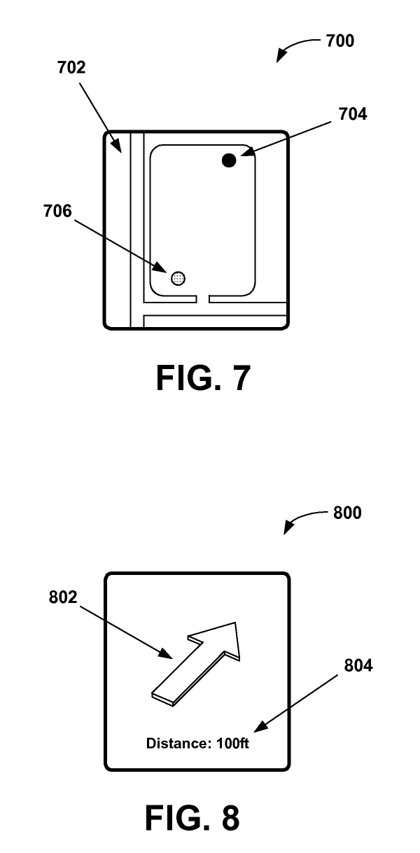

FIG. 7 is a diagram showing an exemplary map based positional information display 700 on a cellular telephone, in accordance with an embodiment of the present invention. The map based positional information display 700 includes a map 702 of the general current surroundings of the cellular telephone. The map 702 can be stored on the cellular telephone, downloaded from the cellular telephone network, or obtained in any other manner as will be appreciated by those skilled in the art after a careful reading of the present disclosure. In addition, the displayed map can be adjusted based on the distance between the asset tracking device and the cellular telephone. For example, when the cellular telephone and asset tracking device are in close proximity, the displayed map can be relatively zoomed in, while if the distance between the cellular telephone and the asset tracking device is large, the displayed map can be zoomed out, mapping a greater area.

Displayed on the map are asset tracking device indicia 704 indicating the position of the asset tracking device and cellular telephone indicia 706 indicating the position of the cellular telephone relative to the asset tracking device. These indicia 704 and 706 are updated continuously to continually display the current positions of the asset tracking device and the cellular telephone. Thus, in the example FIG. 6, since the asset tracking device 202 is located in proximity to the user's automobile 604, the asset tracking device indicia 704 indicates the position of the user's automobile 604. Similarly, since the user 606 is holding the user's cellular telephone 208, the cellular telephone indicia 706 indicates the position of the user 606.

Further, as the user walks around the parking lot 600, the displayed position of the cellular telephone indicia 706 is updated to reflect the new position of the user's cellular telephone 208, and thus the position of the user 606. In this manner, the user 606 can watch the display and continually locate the position of user's automobile 604 relative to the user's position, thus allowing the user to find the user's automobile 604. That is, as the user 606 moves towards the user's automobile, the cellular telephone indicia 706 moves towards the asset tracking device indicia 704, reflecting the user's 606 movement toward the user's automobile 604.

FIG. 8 is a diagram showing an exemplary relative positional information display 800 on a cellular telephone, in accordance with an embodiment of the present invention. In this embodiment, the cellular telephone includes heading indication hardware capable of determining the current heading of the cellular telephone. Based on the current heading and position of the cellular telephone 208 and the current position of the asset tracking device 202, the exemplary relative positional information display 800 shows relative position indicia 802 indicating the relative position of the cellular telephone 208 to the asset tracking device 202.

For example, the relative position indicia 802 can be a pointer pointing in the current direction of the asset tracking device 202 relative to the cellular telephone 208. In addition, one embodiment includes distance information 804 on the display 800. The distance information can include, for example, the current distance between the cellular telephone 208 and the asset tracking device 202. As the user moves while holding the cellular telephone 208, the cellular telephone 208 updates the distance information 804 and the relative position indicia 802 with the new relative position of the cellular telephone 208 to the asset tracking device 202. That is, the relative position indicia 802 pointer continues to point toward the asset tracking device 202 as the user moves. In this manner, the cellular telephone 208 can be utilized similar to a compass, with the indicia indicating the direction to the desired asset.

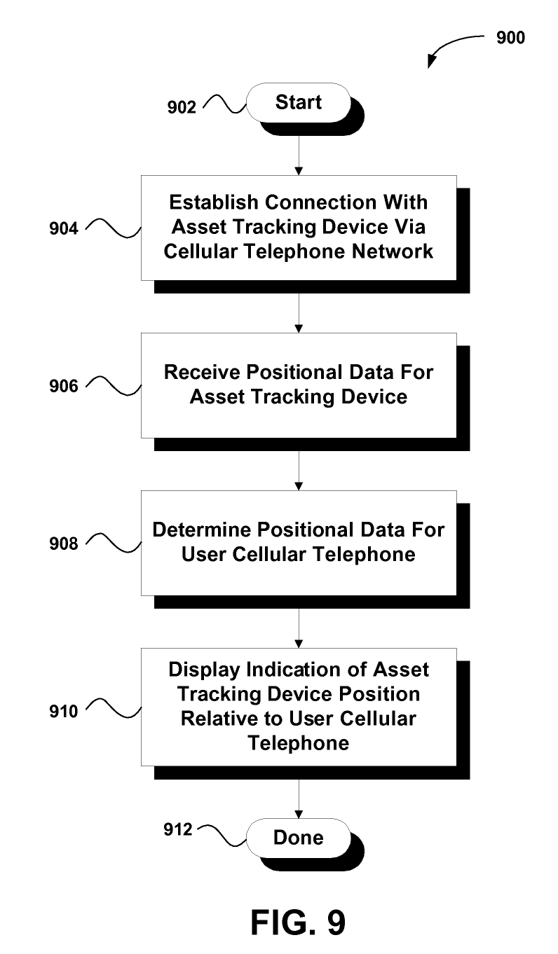

FIG. 9 is a flowchart showing a method 900 for cellular telephone based asset tracking, in accordance with an embodiment of the present invention. In an initial operation 902, preprocess operations are performed. Preprocess operations can include, for example, programming authorization security settings in the asset tracking device, assigning a telephone number to the asset tracking device, programming asset search menus on the cellular telephone, and other preprocess operations that will be apparent to those skilled in the art after a careful reading of the present disclosure.

In operation 904, a cellular telephone establishes a connection with an asset tracking device via a cellular telephone network. For example, the cellular telephone can display a list of assets trackable via the cellular telephone. This list can include, for example, a list of a plurality of asset tracking devices, each designated with a unique identifier allowing the user to choose which asset to track. For example, a user may have a first asset tracking device attached to their car and a second asset tracking device attached to their laptop computer. When tracking an asset, the user can utilize the asset tracking menu to select a particular asset, for example the user can select car to track the user's car. In response, the cellular telephone initiates contact with the selected asset tracking device, for example by calling the associated telephone number of the asset tracking device.

Once contact is established with the asset tracking device, positional data is received for the asset tracking device, in operation 906. As mentioned previously, positional data for the asset tracking device is determined, for example via GPS signals, ALI, LORAN, GLONASS, or any other position determination means as will be apparent to those skilled in the art after a careful reading of the present disclosure. For example, when utilizing GPS signals to determine positional data, GPS circuits within the asset tracking device acquire GPS signals emitted from a minimum number of GPS satellites. Once the GPS circuits lock on to the GPS signals, the current global position of the asset tracking device can be calculated.

When utilizing ALI to determine positional data for the asset tracking device, the cellular telephone network measures CDPD transmissions of the asset tracking device to determine the AOA and TOA at multiple fixed cell towers. The AOA and TOA can then be utilized to calculate the positional data for the asset tracking device. Once the positional data for the asset tracking device is determine, the asset tracking device transmits its positional data to the cellular telephone. Because normal cellular telephone contact is established between the cellular telephone and the asset tracking device, the positional data for the asset tracking device can be transmitted to the cellular telephone via the cell towers of the cellular telephone network.

In addition, positional data for the cellular telephone is determined, in operation 908. As with the asset tracking device, positional data for the cellular telephone is determined, for example via GPS signals, ALI, LORAN, GLONASS, or any other position determination means as will be apparent to those skilled in the art after a careful reading of the present disclosure. For example, when utilizing GPS signals to determine positional data, GPS circuits within the cellular telephone acquire GPS signals and use the acquired GPS signals to calculate the current global position of the cellular telephone. When utilizing ALI to determine positional data for the cellular telephone, the cellular telephone network measures CDPD transmissions of the cellular telephone to determine the AOA and TOA at multiple fixed cell towers. The AOA and TOA can then be utilized to calculate the positional data for the cellular telephone.

In operation 910, the cellular telephone displays indicia indicating the position of the asset tracking device relative to the cellular telephone. Upon receiving the positional information from the asset tracking device, the cellular telephone displays indicia indicating the position of the asset tracking device. As can be appreciated, the asset tracking device generally is positioned within close proximity to a particular asset, for example within a car. Thus, the displayed position of the asset tracking device generally coincides with the position of the associated asset.

In addition to displaying indicia indicating the position of the asset tracking device, one embodiment of the present invention displays indicia indicating the position of the cellular telephone relative to the asset tracking device. As described above, one embodiment of the present invention displays a map of the current surroundings of the cellular telephone with indicia indicating the position of the asset tracking device and the position of the cellular telephone. Generally, as the user moves while holding the cellular telephone, the displayed indicia are updated with new positions of each object.

In a further embodiment, as previously discussed, the cellular telephone displays indicia indicating the relative position of the cellular telephone to the asset tracking device. For example, the indicia can be a pointer pointing in the current direction of the asset tracking device relative to the cellular telephone. As the user moves while holding the cellular telephone, the cellular telephone updates the displayed indicia with the new relative position of the cellular telephone to the asset tracking device. In this manner, the cellular telephone can be utilized similar to a compass, with the indicia indicating the direction to the desired asset.

Post process operations are performed in operation 912. Post process operations can include, for example, updating the displayed indicia for the asset tracking device and/or cellular telephone, updating distance information, closing cellular telephone connections, and other post process operation that will be apparent to those skilled in the art after a careful reading of the present disclosure. In this manner, embodiments of the present invention advantageously allow asset tracking in a mobile environment, where the user is not located at a stationary computer station. Moreover, embodiments of the present invention allow the user to track assets in a non-intrusive manner, utilizing a cellular telephone that is normally carried on the user. Hence, the user typically does not need to carry additional equipment other than their cellular telephone to track any number of asset tracking devices they are authorized to track.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for providing cellular telephone based asset tracking, comprising the operations of:
establishing a connection between a cellular telephone and an asset tracking device via a cellular telephone network;
providing positional data for the asset tracking device to the cellular telephone via the cellular telephone network;
determining positional data for the cellular telephone; and
displaying asset indicia and cellular telephone indicia on a display of the cellular telephone, wherein the asset indicia indicate a current position of the asset tracking device and the cellular telephone indicia indicate a current position of the cellular telephone.

2. A method as recited in claim 1, wherein the asset tracking device utilizes global positioning system (GPS) data to determine the positional data for the asset tracking device.

3. A method as recited in claim 2, further comprising the operation of transmitting the positional data from the asset tracking device to the cellular telephone via the cellular telephone network.

4. A method as recited in claim 1, wherein the cellular telephone network utilizes automatic location identification (ALI) data to determine the positional data for the asset tracking device.

5. A method as recited in claim 1, wherein the asset tracking device does not include a microphone.

6. A method as recited in claim 1, further comprising the operation of updating a displayed position of the cellular telephone indicia such that the displayed position of the cellular telephone indicia shows a new current position of the cellular telephone as the cellular telephone changes position.

7. A method as recited in claim 1, further comprising the operation of updating a displayed position of the asset indicia such that the displayed position of the asset indicia shows a new current position of the asset tracking device as the asset tracking device changes position.

8. A method for providing cellular telephone based asset tracking, comprising the operations of:
establishing a connection between a cellular telephone and an asset tracking device via a cellular telephone network;
providing positional data for the asset tracking device to the cellular telephone via the cellular telephone network;
determining positional data for the cellular telephone; and
displaying relative position indicia showing the relative position of the asset tracking device with respect to the cellular telephone.

9. A method as recited in claim 8, wherein the asset tracking device utilizes global positioning system (GPS) data to determine the positional data for the asset tracking device.

10. A method as recited in claim 9, further comprising the operation of transmitting the positional data from the asset tracking device to the cellular telephone via the cellular telephone network.

11. A method as recited in claim 8, wherein the asset tracking device does not include a microphone.

12. A method as recited in claim 8, further comprising the operation of displaying distance data, the distance data indicating a distance between the cellular telephone and the asset tracking device.

13. A method as recited in claim 8, wherein the relative position indicia comprises a digital pointer pointing in a direction of the asset tracking device relative to the cellular telephone.

14. A method as recited in claim 13, further comprising the operation of updating the digital pointer such that the displayed digital pointer points in a new direction of the asset tracking device relative to the cellular telephone as the cellular telephone changes position.

15. An asset tracking device for providing cellular telephone based asset tracking, comprising:
a cellular receiver and a cellular transmitter;
a modem in communication with the cellular receiver and the cellular transmitter;
an identification data module storing authorization data for an authorized cellular telephone; and
a microprocessor in communication with the modem and the identification data module, wherein the microprocessor compares authorization data received from a cellular telephone with the stored authorization data to determine whether to allow positional data regarding the asset tracking device to be provided to the cellular telephone.

16. An asset tracking device as recited in claim 15, further comprising global positioning system (GPS) circuitry capable of receiving GPS signal data for use in calculating the positional data for the asset tracking device.

17. An asset tracking device as recited in claim 16, wherein the microprocessor transmits the positional data to the cellular telephone upon determining the cellular telephone is authorized to receive the positional data.

18. An asset tracking device as recited in claim 15, wherein the positional data is determined by a cellular telephone network utilizing automatic location identification (ALI) technology.

19. An asset tracking device as recited in claim 18, wherein the microprocessor transmits a signal to the cellular telephone network to provide the positional data to the cellular telephone upon determining the cellular telephone is authorized to receive the positional data.

20. An asset tracking device as recited in claim 15, wherein the asset tracking device does not include a microphone.
